(19) United States
(12) Patent Application Publication
(10) Pub. No.: US 2005/0075412 A1
(43) Pub. Date: Apr. 7, 2005

(54) Granular additive for synthetic resin, and method for manufacturing same

(76) Inventor: Shingo Hishida, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/353,057

(22) Filed: Jan. 29, 2003

(51) Int. Cl. C08K 3/00

(52) U.S. Cl. 523/122

(57) ABSTRACT

A granular resin solid (a) that serves as a nucleus, has a particle size of 0.5 to 7 mm, and is composed of a molding thermoplastic resin, a powdered additive component (b), and a fixing resin (c) composed of a thermoplastic resin are stirred and mixed, the fixing resin (c) is melted by the frictional heat during stirring and mixing, the powdered additive component (b) is made to adhere to the surface of the granular resin solid (a) by the melted fixing resin (c), and the system is cooled while being stirred, which solidifies the fixing resin (c), thereby providing a granular additive with excellent dispersibility and a uniform particle size by an extremely simple method and at low cost. It is also possible to dissolve the fixing resin (c) in a solvent to obtain a liquid adhesive agent (d), which is then stirred and mixed into the granular resin solid (a) and the powdered additive component (b), causing the powdered additive component (b) to adhere to the surface of the granular resin solid (a), and evaporate the solvent of the liquid adhesive agent (d) by further stirring and solidify the fixing resin (c), thereby affixing the additive component (b) to the surface of the granular resin solid (a).

### BACKGROUND OF THE INVENTION

1. Field of the Invention

The present invention relates to a granular additive that is added to a thermoplastic resin used for molding, and to a method for manufacturing this granular additive.

2. Description of the Related Art

Coloring agents have been used in the past as granular additives that are added to molding thermoplastic resins. An example of a coloring agent added to a molding thermoplastic resin is a powdered dry color obtained by treating a dye or pigment with a dispersant. This dry color is easy to manufacture and low in cost, but because it is a powder, a drawback is that the coloring agent can scatter and contaminate the working environment, molding machine, workers, etc. In contrast, granular coloring agents do not have this problem of scattering encountered with dry colors, and they also lend themselves well to precise metering, which makes possible metering with an automatic metering machine and automatic feed to the molding machine.

One such granular coloring agent has been disclosed in Japanese Laid-Open Patent Application H9-104759, for example. In this case, thermoplastic resin particles with a size of 5 to 100 mesh are used as nuclei, and a coloring component composed of a dye or pigment treated with a dispersant is affixed to the surface of these particles. A binder is added as needed to this granular coloring agent. Also, a granular coloring agent composed of a dye or pigment and a fatty acid metal salt (a dispersant) has been proposed in Japanese Laid-Open Patent Application H11-158292. A surfactant or binder is added as needed to this granular coloring agent. Japanese Patent Publication H8-11770 discloses coloring pellets obtained by affixing a dry color to the surface of molding thermoplastic resin pellets with a thermoplastic adhesive agent containing water. However, as mentioned above, a dry color is a powdered coloring agent comprising a dispersant mixed into a dye or pigment.

As discussed above, conventional granular coloring agents for a synthetic resin all consisted of a coloring component that had been surface treated with a dispersant. Also, when other additives besides a coloring agent were used, they were used only after being surface treated with a dispersant such as a surfactant, a fatty acid, a fatty acid metal salt, a fatty acid-based lubricant, a wax, or a composite of these. However, most of the above-mentioned surfactants that used to be used as dispersants were in liquid form, and even those few solids had a low melting point. Similarly, the fatty acids, fatty acid metal salts, and waxes used as a dispersant had a melting point of about 100 to 120° C. and a softening point of about 80° C. Most of these were in the form of a powder, and readily mixed with the additive component. However, when these dispersants are mixed with an additive component, because the additive component mixes so well with the dispersant, some of the particles form granules. Consequently, when a granular resin solid is used as a nucleus and an additive component is affixed to the surface thereof so as to create a granular additive, the mixture becomes heterogeneous, consisting of granules composed of the additive component and the dispersant, and the granular additive produced when the additive is affixed to the surface of the granular resin solid that serves as the nucleus. Furthermore, since the above dispersants have the property of acting a s a lubricant, they have a release action on the surface of the granular resin solid that serves as the nucleus, which is a problem in that it decreases the fixing strength of the additive component to the resin solid surface.

What is known as a master batch is often used as a granular additive. A master batch, though, entails quite a few steps: a first step of mixing and dispersing an additive and any of various dispersants, a second step of mixing a resin with the treated additive produced in the first step, a third step of heating and kneading the above mixture with an extruder or a roll, and a fourth step of cooling and cutting the mixture into granules. Consequently, the problem with a master batch is that it requires a longer manufacturing time, more workers (labor), more factory space, greater electricity consumption, more machinery, and so on.

### SUMMARY OF THE INVENTION

In light of the above problems encountered with additives added to synthetic resins used for molding in the past, it is an object of the present invention to provide, without the use of a dispersant, a granular additive that has good dispersibility and yet has a uniform grain size. The present invention is to provide the above-mentioned granular additive at a lower cost by employing an extremely simple manufacturing method.

As a result of diligent research conducted in light of the above problems encountered with conventional granular additives for a synthetic resin, the inventors discovered that a granular additive with extremely good dispersibility, in which the additive component adheres firmly to the surface of the resin solid that serves as the nucleus, and which has a uniform particle size can be obtained without the use of a dispersant as in the past, by using a molten fixing resin or a liquid adhesive obtained by dissolving a fixing resin in a solvent, and stirring in a mixer having a multi-stage agitation blade, so that the additive component is affixed by the fixing resin to the surface of the granular resin solid that serves as the nucleus.

Specifically, the granular additive for a synthetic resin pertaining to the present invention is such that a resin solid (a), which is composed of at least one type of resin selected from among molding thermoplastic resins and thermoplastic resins that are compatible with molding thermoplastic resins, this resin solid being in granular form with a particle size of 0.5 to 7 mm, is used as a nucleus, and a powdered additive component (b) is affixed to the surface of this resin solid (a) without the use of a dispersant. It is preferable if the additive component (b) is affixed in a proportion of 0.01 to 150 weight parts per 100 weight parts of the resin solid (a). The present invention is also a granular additive for a synthetic resin, wherein the additive component (b) is affixed to the surface of the resin solid (a) serving as the nucleus by a fixing resin (c) composed of at least one type of resin selected from among thermoplastic resins and resins that are compatible with thermoplastic resins. It is preferable if the fixing resin (c) is used in a proportion of 0.1 to 80 weight parts per 100 weight parts of the resin solid (a).

The method for manufacturing a granular additive for a synthetic resin pertaining to the present invention comprises the steps of: stirring and mixing, in a mixer, a resin solid (a), which serves as a nucleus and is composed of at least one type of resin selected from among molding thermoplastic resins and thermoplastic resins that are compatible with molding thermoplastic resins, this resin solid being in granular form with a particle size of 0.5 to 7 mm, a powdered additive component (b), and a fixing resin (c) composed of at least one type of resin selected from among thermoplastic resins and resins that are compatible with thermoplastic resins; melting the fixing resin (c) by the frictional heat generated during this stirring and mixing; affixing the additive component (b) to the surface of the resin solid (a) by the melted fixing resin (c); and then cooling the mixture while stirring to solidify the fixing resin (c) and to affix the additive component (b) to the surface of the resin solid (a). Another method for manufacturing a granular additive for a synthetic resin pertaining to the present invention comprises the steps of: stirring and mixing, in a mixer, a resin solid (a), which serves as a nucleus and is composed of at least one type of resin selected from among molding thermoplastic resins and thermoplastic resins that are compatible with molding thermoplastic resins, this resin solid being in granular form with a particle size of 0.5 to 7 mm, and a powdered additive component (b); then adding, while stirring, a liquid adhesive agent (d) obtained by dissolving a fixing resin (c), composed of at least one type of resin selected from among thermoplastic resins and resins that are compatible with thermoplastic resins, in a solvent; causing the additive component (b) to adhere to the surface of the resin solid (a) by means of this liquid adhesive agent (d); and then continuing stirring to evaporate the solvent of the liquid adhesive agent (d) and solidify the fixing resin (c), so that the additive component (b) is affixed to the surface of the resin solid (a).

Also, with the manufacturing method of the present invention, when the three components comprising (a) the granular resin solid that serves as the nucleus, (b) the various powdered additive components, and (c) the fixing resin are put into a mixer and stirred and mixed at a suitable speed, the granular resin solid (a) that serves as the nucleus functions as balls, just as if the components were being mixed in a ball mill, and the result is an excellent dispersion effect. Here, the fixing resin (c) melted by the heat, or the liquid adhesive (d) obtained by dissolving the fixing resin (c) in a solvent is kneaded together with the additive component (b), yielding a granular additive in which the powdered additive component (b) is affixed in an excellent dispersion state to the surface of the granular resin solid (a) that serves as the nucleus.

Also, the above-mentioned method for manufacturing a granular additive pertaining to the present invention is an extremely simple method that involves nothing more than mixing in a mixer, so compared to a conventional method for manufacturing a master batch, manufacturing takes less time, requires fewer workers (less labor), takes up less factory space, consumes less electricity, requires less machinery, and so on, all of which lower the cost of manufacturing a granular additive.

### DESCRIPTION OF THE PREFERRED EMBODIMENTS

There are no particular restrictions on the powdered synthetic resin additive that is the object of the present invention, as long as it is an additive to synthetic resins used for molding. Examples of the additive component (b) include, but are not limited to, colorants, plasticizers, antioxidants, UV absorbents, anti-static agents, foaming agents, lubricants, mildew inhibitors, flame retardants, thickeners, and inorganic fillers.

Examples of molding resins include polyethylene, polypropylene, ethylene-vinyl acetate copolymer (EVA), ethylene-ethyl acrylate copolymer (EEA), polystyrene, high impact polystyrene (HIPS), methacrylic resin (MMA), acrylonitrile-butadiene-styrene resin (ABS), polybutylene terephthalate (PBT), polyethylene terephthalate (PET), polycarbonate (PC), nylon, elastomers, and various other thermoplastic resins.

Examples of the resin in the granular resin solid (a) that serves as the nucleus include the above-mentioned molding thermoplastic resins, thermoplastic resins compatible with these, and mixtures of two or more types of these resins, but the use of a molding thermoplastic resin is preferred. Examples of thermoplastic resins that are compatible with the above-mentioned molding thermoplastic resins include coumarone resins, petroleum resins, terpene resins, polyvinylbutyrals, polyvinylformals, and low molecular weight resins. This granular resin solid (a) that serves as the nucleus should have a particle size of 0.5 to 7 mm. The phrase “particle size of the granular resin solid (a)” as used in the present invention means the maximum diameter of the granular resin solid (a), and in the case of disk-shaped or cylindrical resin pellets, the diameter is 0.5 to 7 mm and the length (thickness) is 0.5 to 7 mm, while in the case of a pulverized material, the particles should pass through a sieve with 7 mm openings, but should be large enough not to pass through a sieve with openings smaller than 0.5 mm. Further, in the case of a pulverized material, it is preferable to use one with a narrow particle size distribution, one that has been adjusted in size (graded) by being put through a two-stage (top and bottom) sieve with an opening size of 0.5 to 7 mm. This resin solid (a) that serves as the nucleus could not truly be called granular if its particle size were less than 0.5 mm, and would more accurately be a powder, and mixing such a powder with molding resin pellets poses a problem in that the difference in bulk specific gravity results in separation and an uneven mixture. On the other hand, it is also undesirable for the particle size of the resin solid (a) to be greater than 7 mm because fewer granular additive particles will end up being added, and there will be a large difference in the number of particles of granular additive and that of resin pellets in the mixture with the molding resin pellets, which again results in an uneven mixture. Also, a granular resin solid of the above size can be manufactured in large quantity as molding resin pellets, which keeps the manufacturing cost down, and the molding resin pellets can be used directly as the granular resin solid (a) that serves as the nucleus, so no secondary processing or the like is necessary.

Examples of the fixing resin (c) include thermoplastic resins, resins compatible with these, and mixtures of two or more types of these resins. It is preferable for the fixing resin (c) to be one capable of forming a pliant, rubber-like film, so that the film formed by this fixing resin (c) will not be brittle. Of the various fixing resins (c) that can be used, those used in molten form preferably have a melting point of about 60 to 140° C, and preferably have a melting point lower than that of the resin in the granular resin solid (a) that serves as the nucleus. This kind of fixing resin (c) can be melted during stirring and mixing to create a film that covers the surface of the granular resin solid (a) that serves as the nucleus, which affixes the additive component (b) to the surface of the resin solid (a). Examples of this fixing resin (c) include EVA resins, petroleum resins, vinyl acetate resins, butadiene resins, low molecular weight polyethylene resins, polypropylene resins, ionomer resins, and acrylic resins. Of the various fixing resins (c) that can be used, examples of those used as a liquid adhesive by being dissolved in a solvent include polyvinylbutyrals, high impact polystyrenes (HIPS), ABS resins, acrylic resins, butadiene resins, and polyamide resins. The liquid adhesive (d) obtained by dissolving this fixing resin (c) in a solvent is added to and mixed with the mixture of the granular resin solid (a) and the powdered additive component (b), and affixes the additive component (b) to the surface of the resin solid (a). It is preferable for the solvent used to dissolve the fixing resin (c) to be a non-flammable solvent such as methylene chloride. Methylene chloride is non-flammable, and poses no working hazard of ignition or explosion caused by static electricity generated during the mixing of the granular resin solid (a) with the additive component (b) and the fixing resin (c). Furthermore, the chlorine in methylene chloride is removed from the mixture by evaporation during stirring and mixing, so there is no problem of chlorine remaining in the granular additive. Also, methylene chloride has a low boiling point and a high specific gravity, so mixing in a suitable amount of toluene or the like is a preferred embodiment.

As to the usage proportions of the granular resin solid (a) that serves as the nucleus and the powdered additive component (b), the powdered additive component (b) is used in an amount of 0.01 to 150 weight parts per 100 weight parts granular resin solid (a). The reason the range is so wide for the usage proportion of the additive component (b) is that when the additive component (b) is a colorant, for instance, the added amount thereof can vary widely, resulting in anything from an extremely pale color to a completely opaque color, and even with other types of additives, some are added in minute amounts, such as UV absorbents and anti-static agents, and some are added in large amounts, such as thickeners and inorganic additives. Still, the amount of additive component (b) that adheres to the granular resin solid (a) that serves as the nucleus is determined by the surface area of the resin solid (a), and at the same time is affected by the bulk specific gravity of the additive component (b). It is undesirable for the proportion of the additive component (b) to be more than 150 weight parts per 100 weight parts of the resin solid (a) that serves as the nucleus because the fixing may be inadequate.

The amount in which the fixing resin (c) is used is affected by the amount of additive component (b) used, but when only a tiny amount of additive component (b) is to be affixed to the surface of the granular resin solid (a) that serves as the nucleus, the targeted fixing strength can be achieved by using the fixing resin (c) in an amount of about 0.5 weight part (as solids) per 100 weight parts of the resin solid (a). When a large amount of additive component (b) is to be affixed, or when a additive component (b) with a low bulk specific gravity is used, the fixing resin (c) is used in a suitable amount not exceeding 80 weight parts per 100 weight parts of the granular resin solid (a) that serves as the nucleus. If the amount of fixing resin (c) is over the above range, there is the danger that granules will only be formed between the additive component (b) and the fixing resin (c), resulting in separation from the granular resin solid (a) that serves as the nucleus and poor product quality.

As long as the object of the present invention is not compromised, any dispersant used in the past, such as a surfactant, metallic soap, fatty acid, or wax, can be added in a small amount to the granular additive for a synthetic resin of the present invention.

Next, the methods for manufacturing the granular additive for a synthetic resin of the present invention will be described. First, one of the manufacturing methods of the present invention is a method in which a granular resin solid (a) that serves as a nucleus, a powdered additive component (b), and a fixing resin (c) are stirred and mixed in a mixer, the fixing resin (c) is melted by the frictional heat generated during this stirring and mixing, the additive component (b) is bonded in the form of a film to the surface of the granular resin solid (a) by the melted fixing resin (c), and the mixture is cooled while being stirred, which solidifies the fixing resin (c) and affixes the additive component (b) to the surface of the granular resin solid (a). The mixer used here preferably has an agitation blade, and even more preferably, two or more stages of propeller-shaped agitation blades are attached to a rotary shaft inside the mixer (two or more blades attached in series to a single rotary shaft), and even more preferably, the mixer has a multi-stage agitation blade attached in numerous stages. All three components (the granular resin solid (a) that serves as the nucleus, the powdered additive component (b), and the fixing resin (c)) are put into the mixer at the same time, and stirring and mixing are continued for about 10 to 15 minutes at a high speed, such as 1300 rpm or higher. As a result, the entire mixture is heated to 120° C. or higher by the frictional heat generated between the mixture and the agitation blades and mixer inner walls in contact with the mixture. This melts the fixing resin (c), which forms a film on the surface of the granular resin solid (a) that serves as the nucleus, affixing the additive component (b) to the surface of the resin solid (a). After this, the speed of the mixer is reduced to about 100 rpm, the mixer hatch is opened and the contents are cooled while being stirred for about 5 minutes., and the fixing resin (c) is solidified, which yields a granular additive in which the additive component (b) is affixed to the surface of the granular resin solid (a) by the fixing resin (c). The time this procedure takes can be shortened by heating the walls inside the mixer during the above-mentioned stirring and mixing so as to raise the mixer internal temperature faster.

Another method for manufacturing a granular additive of the present invention is a method in which a resin solid (a) that serves as a nucleus and a powdered additive component (b) are stirred and mixed in a mixer, after which a liquid adhesive agent (d) obtained by dissolving a fixing resin (c) in a solvent is gradually added under stirring, the additive component (b) is made to adhere to the surface of the resin solid (a) by this liquid adhesive agent (d), and then stirring is continued to evaporate the solvent of the liquid adhesive agent (d) and solidify the fixing resin (c), which affixes the additive component (b) to the surface of the resin solid (a). More specifically, for example, the granular resin solid (a) that serves as the nucleus and the powdered additive component (b) are put into a mixer having a multi-stage agitation blade (as discussed above), and are thoroughly stirred and mixed for about 5 minutes at a high speed of at least 1300 rpm. The speed of the mixer is then lowered to a medium speed of about 500 to 600 rpm, and the liquid adhesive agent (d) is slowly added while the stirring and mixing are continued with the mixer hatch open. The addition of the liquid adhesive agent (d) is completed in about 3 minutes, which results in the surface of the granular resin solid (a) being covered with the liquid adhesive agent (d), and in the powdered additive (b) adhering to the surface of the resin solid (a). Upon completion of the addition of the liquid adhesive agent (d), the mixer is run at a low speed of about 100 rpm with the hatch left open, which evaporates the solvent. The solvent evaporates within about 5 minutes, and this yields a granular additive in which the additive component (b) is affixed to the surface of the granular resin solid (a) that serves as the nucleus by the fixing resin (c).

Furthermore, when the fixing resin (c) is melted during stirring and mixing in the mixer and the additive component (b) is affixed to the surface of the granular resin solid (a) that serves as the nucleus as above, if all or part of the granular resin solid (a) and the fixing resin (c) are put into the mixer and heated to about the softening point of the fixing resin (c) by the frictional heat generated by high speed rotation, the fixing resin (c) will be in close contact with part of the surface of the granular resin solid (a) that serves as the nucleus, and when the additive component (b) is added and the fixing resin (c) is completely melted by the stirring and mixing, the resulting granular additive will have the additive component (b) affixed more securely to the surface of the granular resin solid (a). Also, if a small amount of the fixing resin (c) is added at the very end of the finishing process so as to cover the additive component (b) adhering to the surface of the resin solid (a), the additive component (b) will be affixed more securely to the surface of the granular resin solid (a) that serves as the nucleus. Even when the liquid adhesive agent (d) (produced by dissolving the fixing resin (c) in a solvent) is used, the additive component (b) can be made to adhere tightly to the surface of the granular resin solid (a) that serves as the nucleus by adding a small amount of the liquid-adhesive agent (d) prior to the addition of the additive component (b) so as to wet the surface of the granular resin solid (a) that serves as the nucleus with the liquid adhesive agent (d), and then adding the additive component (b), mixing, and then slowly adding the liquid adhesive agent (d) in the same manner as above. In addition, the additive component can be made to adhere more securely to the surface of the resin solid by first bonding the additive component (b) to the surface of the granular resin solid (a) that serves as the nucleus with the liquid adhesive agent (d), and then adding another small amount of liquid adhesive agent (d) so that the surface of the granular resin solid to which the additive component (b) has adhered is further covered with the liquid adhesive agent (d).

### EXAMPLES

Examples of the present invention will now be given, but these examples do not limit the present invention in any way. The materials used in the examples are listed below. The numbers and symbols used for the materials below correspond to the numbers and symbols in the tables.

[Additive Components]

(1) titanium oxide (SR-1 made by Sakai Chemical Industry)

(2) iron oxide red 40G made by Morishita Bengara Kogyo)

(3) titanium yellow (TY-70 made by Ishihara Sangyo)

(4) phthalocyanine blue (PS made by Dainippon Ink & Chemicals)

(5) oil yellow dye (Yellow 433 made by Nippon Kayaku)

(6) oil orange dye (JLS-PS made by Nippon Kayaku)

(7) UV absorbent (Seesorb 703 made by Shipro Kasei)

(8) antioxidant (Irganox 1070 made by Ciba-Geigy)

(9) antioxidant (Tinuvin 327 made by Ciba-Geigy)

(10) carbon black (MA-100 made by Mitsubishi Chemical)

(11) anti-static agent (TB-123 made by Matsumoto Yushi)

(12) calcium carbonate (CA-1 made by Bihoku Kogyo)

[Fixing Resins]

(A) EVA resin (Ultrathene 537 made by Tosoh; melting point 81° C.)

(B) petroleum resin (Piccolastic made by Yuka Hercules; melting point 80 to 100° C.)

(C) polyvinylbutyral (Elsec BX-2 made by Sekisui Chemical;

melting point 120° C.; used as a liquid adhesive agent in which the resin solid component (N.V.) is dissolved in an amount of 20 wt % in a mixed solvent composed of 70% methylene chloride and 30% toluene)

[Granular Resin Solids (Nucleus Resins), Molding Resins]

(#1) polypropylene resin pellets (J-105W made by Grand Polymer; disk-shaped pellets with a diameter of 4.5 mm and a thickness of 2.5 mm; labeled PP resin pellets in Table 1)

(#2) polystyrene resin pellets (CR-3500G made by Dainippon Ink & Chemicals; cylindrical pellets with a diameter of 1.2 mm and a length of 1.6 mm; labeled PS resin pellets in the tables)

(#3) ABS resin pellets (Kralatic GA101 made by Nihon A and L;

pulverized and graded with a two-stage sieve, the upper stage of which has an opening size of 3 mm and the lower stage of which has an opening size of 2 mm)

### Examples 1 to 10

Additive components, fixing resins, and granular resin solids that served as the nucleus (nucleus resins) were added simultaneously in the proportions shown in Table 1 below to a mixer having an agitation blade, and were stirred and mixed for about 10 minutes. The mixer was made of stainless steel and had a capacity of 20 liters, and a multi-stage agitation blade was attached to a rotary shaft. When the agitation blade was rotated at a high speed of 1700 rpm to stir and mix them for ten minutes, the internal temperature rose to about 120° C. due to frictional heat between the mixer internal walls and the agitation blades in contact with the mixture, and this melted the fixing resin and caused the additive component to adhere to the surface of the granular resin solid serving as the nucleus. The speed of the mixer was set at about 100 rpm, and stirring was continued with the mixer hatch left open while the contents cooled for about 5 minutes, whereupon the fixing resin solidified, yielding a granular additive in which the additive component was affixed to the surface of the resin solid serving as the nucleus.

### Examples 11 to 16

Additive components and granular resin solids that served as the nucleus (nucleus resins) were added simultaneously in the proportions shown in Table 1 below to the same mixer as above, and were stirred and mixed for about 5 minutes at a medium speed of 500 rpm. The rotation of the mixer was then halted temporarily, then a fixing resin (liquid adhesive agent) was added over a period of about 3 minutes while the mixer was run at a low speed of 100 rpm with its hatch left open, after which stirring was continued for about 5 minutes, whereupon the solvent evaporated, yielding a granular additive in which the additive component was affixed to the surface of the resin solid serving as the nucleus.

TABLE 1

| | | Example Number | | | | | | | | | | | | | | | |
|---|---|---|---|---|---|---|---|---|---|---|---|---|---|---|---|---|---|
| Components (weight parts) | | 1 | 2 | 3 | 4 | 5 | 6 | 7 | 8 | 9 | 10 | 11 | 12 | 13 | 14 | 15 | 16 |
| Additive | titanium oxide (1) | 5 | 5 | 5 | 1 | 1 | 1 | 5 | 5 | 5 | 5 | 5 | 5 | 5 | 5 | 5 | 5 |
| component | iron oxide red (2) | 0.5 | 0.5 | 0.5 | — | — | — | — | — | — | — | — | — | — | — | — | — |
| | titanium yellow (3) | 1 | 1 | 1 | 0.5 | 0.5 | 0.5 | — | — | — | — | — | — | — | — | — | — |
| | phthalocyanine blue (4) | — | — | — | 0.6 | 0.6 | 0.6 | — | — | — | — | — | — | — | — | — | — |
| | oil yellow dye (5) | — | — | — | — | — | — | 0.4 | 0.4 | 0.4 | 0.4 | — | — | — | — | — | — |
| | oil orange dye (6) | — | — | — | — | — | — | 0.1 | 0.1 | 0.1 | 0.1 | — | — | — | — | — | — |
| | UV absorbent (7) | — | — | — | 0.5 | 0.5 | 0.5 | — | — | — | — | — | — | — | — | — | — |
| | antioxidant (8) | — | — | — | — | — | — | — | — | 0.5 | 0.5 | — | — | — | — | — | — |
| | antioxidant (9) | — | — | — | — | — | — | — | — | 0.5 | 0.5 | — | — | — | — | — | — |
| | carbon black (10) | — | — | — | — | — | — | — | — | — | — | 0.2 | 0.2 | 0.2 | 0.2 | 0.2 | 0.2 |
| | anti-static agent (11) | — | — | — | — | — | — | — | — | — | — | 0.3 | 0.3 | 0.3 | 1 | 1 | 1 |
| | calcium carbonate (12) | — | — | — | — | — | — | — | — | — | — | — | — | — | 1 | 1 | 1 |
| Fixing | EVA (A) | 1.5 | 1.5 | 1.5 | 1.5 | 1.5 | 1.5 | — | — | — | — | — | — | — | — | — | — |
| resin | petroleum resin (B) | — | — | — | — | — | — | 2 | 2 | 2.5 | 2.5 | — | — | — | — | — | — |
| | polyvinylbutyral (C) (N.V.) | — | — | — | — | — | — | — | — | — | — | 1 | 1 | 1 | 1 | 1 | 1 |
| Nucleus | PP resin pellets (#1) | 4 | — | — | 4 | — | — | — | — | — | — | 6 | — | — | 6 | — | — |
| resin | PS resin pellets (#2) | — | 4 | — | — | 4 | — | 6 | — | 6 | — | — | 6 | — | — | 6 | — |
| | ABS resin pellets (#3) | — | — | 4 | — | — | 4 | — | 6 | — | 6 | — | — | 6 | — | — | 6 |

The surfaces of the granular additives of Examples 1 to 16 obtained above were examined, and the adhesion of the additive component was evaluated in three levels (good, fair, poor), the results of which are given in Table 2 below. It was determined that the adhesion of the additive component was poor by noting whether a powder was admixed.

Also, the granular additives of Examples 1 to 16 were added in the proportions show in Table 2 below to 100 weight parts of molding polypropylene resin pellets (#1) polystyrene resin pellets (#2), and ABS resin pellets (#3), test pieces were manufactured by injection molding, and the dispersibility of the additive in the moldedd article was evaluated in three levels (good, fair, poor), the results of which are given in Table 2 below. It was determined that the dispersibility was poor by noting the intensity of the color of the molded article.

TABLE 2

| | | Injection molding resin (wt. pts.) | | Dis- |
|---|---|---|---|---|
| Example | Surface | | Granular | pers- |
| number | adhesion | Molding resin | additive | ibility |
| 1 | good | PP resin pellets (#1): 100 | 3 | good |
| 2 | good | PS resin pellets (#2): 100 | 3 | good |
| 3 | good | ABS resin pellets (#3): 100 | 3 | good |
| 4 | good | PP resin pellets (#1): 100 | 3 | good |
| 5 | good | PS resin pellets (#2): 100 | 3 | good |
| 6 | good | ABS resin pellets (#3): 100 | 3 | good |
| 7 | good | PS resin pellets (#2): 100 | 1 | good |
| 8 | good | ABS resin pellets (#3): 100 | 2 | good |
| 9 | good | PS resin pellets (#2): 100 | 1 | good |
| 10 | good | ABS resin pellets (#3): 100 | 2 | good |
| 11 | good | PP resin pellets (#1): 100 | 3 | good |
| 12 | good | PS resin pellets (#2): 100 | 3 | good |
| 13 | good | ABS resin pellets (#3): 100 | 3 | good |
| 14 | good | PP resin pellets (#1): 100 | 3 | good |
| 15 | good | PS resin pellets (#2): 100 | 3 | good |
| 16 | good | ABS resin pellets (#3): 100 | 3 | good |

As is clear from the results in Table 2, with the granular additives of the examples, the additive component adhered well to the surface of the granular resin solid that served as the nucleus, and when these granular additives were added to a molding resin and a molded article was manufactured, the dispersibility of the additive component was excellent.

Also, in these examples, since the product can be manufactured simply, with just a mixer, compared to a conventional method for manufacturing a granular additive such as a master batch, manufacturing takes less time, requires fewer workers (less labor), takes up less factory space, consumes less electricity, requires less machinery, and so on, all of which lower the cost of manufacturing a granular additive.

As discussed above, the granular additive for a synthetic resin pertaining to the present invention is such that the additive component (b) is affixed to the surface of a resin solid (a) that serves as the nucleus by a fixing resin (c) such as a thermoplastic resin, without any dispersant being used, so granules composed of additive component and dispersant are not produced as was the case when a dispersant was used. Therefore, the present invention yields a granular additive that is composed only of the additive component (b) affixed to the surface of the resin solid (a) that serves as the nucleus, and this granular additive is homogeneous and substantially uniform in particle size. Also, since no component is used that would have the action of a release agent, such as a dispersant, the additive component is securely affixed to the surface of the resin solid serving as the nucleus, the additive component does not fall out as a powder during transport or in the hopper, and there is no fouling of the molding machinery or the like with the colorant or other such additive component.

Also, the manufacturing method of the present invention merely requires that the three components (the resin solid (a) that serves as the nucleus, the additive component (b), and the fixing resin (c)) be stirred in a mixer, which results in the fixing resin (c) being melted by the frictional heat during stirring, and the additive component (b) adhering to the resin solid (a), after which the fixing resin is cooled and solidified, thereby securely affixing the additive component (b) to the surface of the resin solid (a) that serves as the nucleus. Also, the other method for manufacturing a granular additive of the present invention merely requires that the three components comprising the resin solid (a) that serves as the nucleus, the additive component (b), and the liquid adhesive agent (d) obtained by dissolving the fixing resin (c) in a solvent be stirred in a mixer, which results in the liquid adhesive agent (d) causing the additive component (b) to adhere to the resin solid, after which the solvent of the liquid adhesive agent (d) is evaporated to solidify the fixing resin (c), thereby securely affixing the additive component (b) to the surface of the resin solid (a). Therefore, the methods of the present invention allow a granular additive to be manufactured with the greatest of ease and at low cost.

1. A granular additive for a synthetic resin, in which a resin solid (a), which is composed of at least one type of resin selected from among molding thermoplastic resins and thermoplastic resins that are compatible with said molding thermoplastic resins, this resin solid being in granular form with a particle size of 0.5 to 7 mm, is used as a nucleus, and a powdered additive component (b) is affixed to the surface of this resin solid (a) without the use of a dispersant.

2. The granular additive for a synthetic resin according to claim 1, wherein the additive component (b) is affixed in a proportion of 0.01 to 150 weight parts per 100 weight parts of the resin solid (a).

3. The granular additive for a synthetic resin according to claim 1 or 2, wherein the additive component (b) is affixed to the surface of the resin solid (a) by a fixing resin (c) composed of at least one type of resin selected from among thermoplastic resins and resins that are compatible with thermoplastic resins.

4. The granular additive for a synthetic resin according to claim 3, wherein the fixing resin (c) is used in an amount of 0.1 to 80 weight parts per 100 weight parts of the resin solid (a).

5. A method for manufacturing a granular additive for a synthetic resin, comprising the steps of:
stirring and mixing, in a mixer, a resin solid (a), which serves as a nucleus and is composed of at least one type of resin selected from among molding thermoplastic resins and thermoplastic resins that are compatible with molding thermoplastic resins, this resin solid being in granular form with a particle size of 0.5 to 7 mm, a powdered additive component (b), and a fixing resin (c) composed of at least one type of resin selected from among thermoplastic resins and resins that are compatible with thermoplastic resins;
melting the fixing resin (c) by the frictional heat generated during this stirring and mixing;
affixing the additive component (b) to the surface of the resin solid (a) by the melted fixing resin (c); and
then cooling the mixture while stirring to solidify the fixing resin (c) and to affix the additive component (b) to the surface of the resin solid (a).

6. A method for manufacturing a granular additive for a synthetic resin, comprising the steps of:
stirring and mixing, in a mixer, a resin solid (a), which serves as a nucleus and is composed of at least one type of resin selected from among molding thermoplastic resins and thermoplastic resins that are compatible with molding thermoplastic resins, this resin solid being in granular form with a particle size of 0.5 to 7 mm, and a powdered additive component (b);
then adding, while stirring, a liquid adhesive agent (d) obtained by dissolving a fixing resin (c), composed of at least one type of resin selected from among thermoplastic resins and resins that are compatible with thermoplastic resins, in a solvent;
causing the additive component (b) to adhere to the surface of the resin solid (a) by means of this liquid adhesive agent (d); and
then continuing stirring to evaporate the solvent of the liquid adhesive agent (d) and solidify the fixing resin (c), so that the additive component (b) is affixed to the surface of the resin solid (a).

7. The method for manufacturing a granular additive for a synthetic resin according to claim 6, wherein a non-flammable solvent or a mixed solvent containing a non-flammable solvent is used as the solvent in which the fixing resin (c) is dissolved.

8. The granular additive for a synthetic resin according to claim 2, wherein the additive component (b) is affixed to the surface of the resin solid (a) by a fixing resin (c) composed of at least one type of resin selected from among thermoplastic resins and resins that are compatible with thermoplastic resins.

9. The granular additive for a synthetic resin according to claim 8, wherein the fixing resin (c) is used in an amount of 0.1 to 80 weight parts per 100 weight parts of the resin solid (a).
